(19) United States
(12) Patent Application Publication
(10) Pub. No.: US 2018/0097914 A1
(43) Pub. Date: Apr. 5, 2018

(54) HOST MACHINE DISCOVERY AND CONFIGURATION

(71) Applicant: Nutanix, Inc., San Jose, CA (US)

(72) Inventors: Jan Ralf Alexander Olderdissen, Herrenberg (DE); Miao Cui, New York, NY (US)

(21) Appl. No.: 15/285,424

(22) Filed: Oct. 4, 2016

(51) Int. Cl. H04L 29/08; H04L 29/06

(52) U.S. Cl. CPC H04L 67/34; H04L 67/10; H04L 67/42

(57) ABSTRACT

In one embodiment, a system includes a client machine executing a first software module for managing host machines, the client machine being installed with a software application and including a proxy module. The system also includes multiple host machines, each of the host machines executing a second software module for communicating with the first software module, wherein at least one of the host machines is running a service for managing one or more host machines. The client machine may manage the host machines by causing the first software module to send a request for information to the multiple host machines, receiving responses from the host machines, sending a request formatted with an IPv4 address using the software application, and causing the proxy module to intercept the request formatted with the IPv4 address and send instructions using an IPv6 link local address to a selected one of the host machines.

### TECHNICAL FIELD

This disclosure generally relates to discovering and configuring host machines within a virtualization environment.

### BACKGROUND

A “virtual machine” or a “VM” refers to a specific software-based implementation of a machine in a virtualization environment, in which the hardware resources of a real computer (e.g., CPU, memory, etc.) are virtualized or transformed into the underlying support for the fully functional virtual machine that can run its own operating system and applications on the underlying physical resources just like a real computer.

Virtualization works by inserting a thin layer of software directly on the computer hardware or on a host operating system. This layer of software contains a virtual machine monitor or “hypervisor” that allocates hardware resources dynamically and transparently. Multiple operating systems run concurrently on a single physical computer and share hardware resources with each other. By encapsulating an entire machine, including CPU, memory, operating system, and network devices, a virtual machine is completely compatible with most standard operating systems, applications, and device drivers. Most modern implementations allow several operating systems and applications to safely run at the same time on a single computer, with each having access to the resources it needs when it needs them.

Virtualization allows one to run multiple virtual machines on a single physical machine, with each virtual machine sharing the resources of that one physical computer across multiple environments. Different virtual machines can run different operating systems and multiple applications on the same physical computer.

One reason for the broad adoption of virtualization in modern business and computing environments is because of the resource utilization advantages provided by virtual machines. Without virtualization, if a physical machine is limited to a single dedicated operating system, then during periods of inactivity by the dedicated operating system the physical machine is not utilized to perform useful work. This is wasteful and inefficient if there are users on other physical machines which are currently waiting for resources (e.g., computing, storage, or network resources). To address this problem, virtualization allows multiple VMs to share the underlying physical resources so that during periods of inactivity by one VM, other VMs can take advantage of the resource availability to process workloads. This can produce great efficiencies for the utilization of physical devices, and can result in reduced redundancies and better resource cost management.

Furthermore, there are now products that can aggregate multiple physical machines, running virtualization environments to not only utilize the processing power of the physical devices to aggregate the storage of the individual physical devices to create a logical storage pool wherein the data may be distributed across the physical devices but appears to the virtual machines to be part of the system that the virtual machine is hosted on. Such systems operate under the covers by using metadata, which may be distributed and replicated any number of times across the system, to locate the indicated data. These systems are commonly referred to as clustered systems, wherein the resources of the group are pooled to provide logically combined, but physically separate systems.

### SUMMARY OF PARTICULAR EMBODIMENTS

The present invention provides an architecture for discovering and configuring host machines in a virtualization environment. In particular embodiments, an administrator of a clustered system may desire to remotely configure, via a client machine, one or more host machines that have not been assigned to the clustered system and do not have assigned IP addresses. The configuration may include assigning the host machines to the clustered system, forming a new cluster or clusters from unassigned host machines, assigning IP addresses to the host machines, or installing software on the host machines. At least one of the unassigned host machines may run a service for managing the host machines. In particular embodiments, the client machine may implement a discovery protocol by sending a request for information to a plurality of host machines, receiving from the host machines responses comprising, for example, identification information, configuration information, network positions, or version information of the software for the service for managing host machines, and aggregating the received responses into a list of discovered host machines. The administrator may then configure one or more of the discovered host machines, via the client machine, by selecting one of the listed host machines, using a browser client to generate instructions formatted with an IPv4 address for the selected host machine, using a proxy module to convert the IPv4 address into a IPv6 link local address and forward the instructions to the select host machine, and instructing the service run by the select host machine to configure one or more other host machines. Particular embodiments of the present invention allow the administrator to access unknown host machines on a network, to assign the host machines to a clustered virtualization environment, and to effectively configure the newly-added host machines.

Further details of aspects, objects, and advantages of the invention are described below in the detailed description, drawings, and claims. Both the foregoing general description and the following detailed description are exemplary and explanatory, and are not intended to be limiting as to the scope of the invention. Particular embodiments may include all, some, or none of the components, elements, features, functions, operations, or steps of the embodiments disclosed above. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates a clustered virtualization environment according to some embodiments of the invention.

FIG. 1B illustrates data flow within a clustered virtualization environment according to some embodiments of the invention.

FIGS. 2A-2D illustrate an example network environment implementing an example discovery protocol according to particular embodiments of the invention.

FIG. 3 illustrates an example method for discovering host machines and installing software on the discovered host machines according to some embodiments of the invention.

FIG. 4 illustrates a block diagram of a computing system suitable for implementing an embodiment of the present invention.

### DESCRIPTION OF EXAMPLE EMBODIMENTS

The present invention provides an architecture for discovering and configuring host machines in a virtualization environment. In particular embodiments, an administrator of a clustered system may desire to remotely configure, via a client machine, one or more host machines that have not been assigned to the clustered system and do not have assigned IP addresses. The configuration may include assigning the host machines to the clustered system, forming a new cluster or clusters from unassigned host machines, assigning IP addresses to the host machines, or installing software on the host machines. At least one of the unassigned host machines may run a service for managing the host machines. In particular embodiments, the client machine may implement a discovery protocol by sending a request for information to a plurality of host machines, receiving from the host machines responses comprising, for example, identification information, configuration information, network positions, or version information of the software for the service for managing host machines, and aggregating the received responses into a list of discovered host machines. The administrator may then configure one or more of the discovered host machines, via the client machine, by selecting one of the listed host machines, using a browser client to generate instructions formatted with an IPv4 address for the selected host machine, using a proxy module to convert the IPv4 address into a IPv6 link local address and forward the instructions to the select host machine, and instructing the service run by the select host machine to configure one or more other host machines. Particular embodiments of the present invention allow the administrator to access unknown host machines on a network, to assign the host machines to a clustered virtualization environment, and to effectively configure the newly-added host machines.

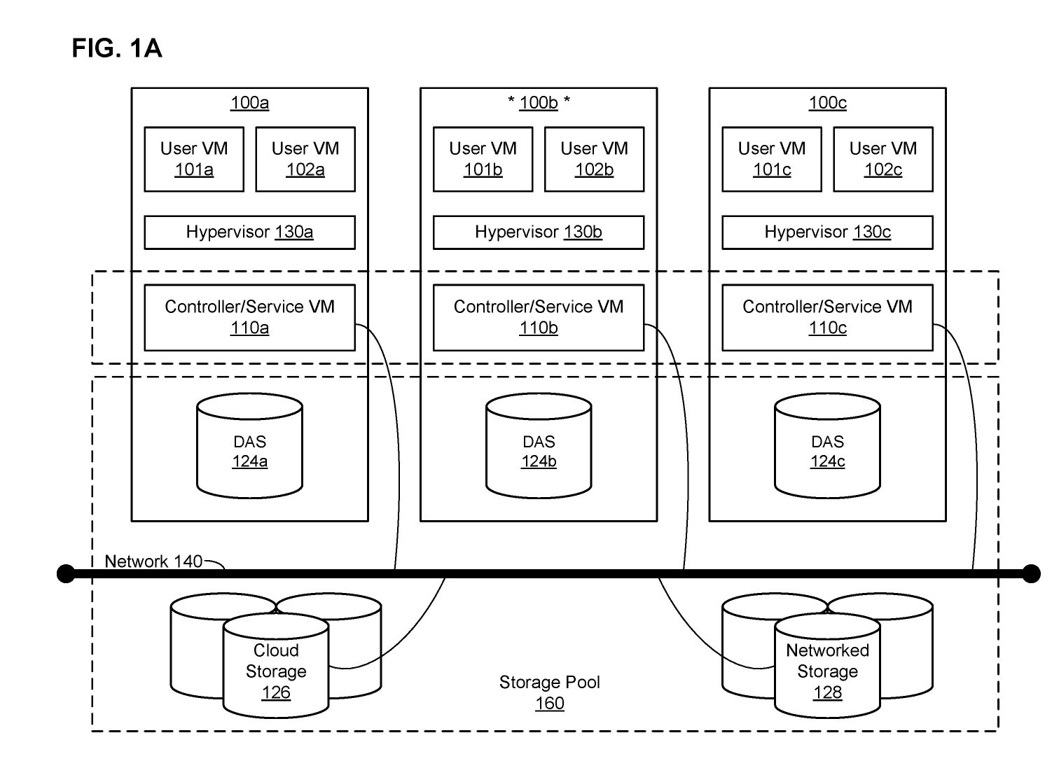

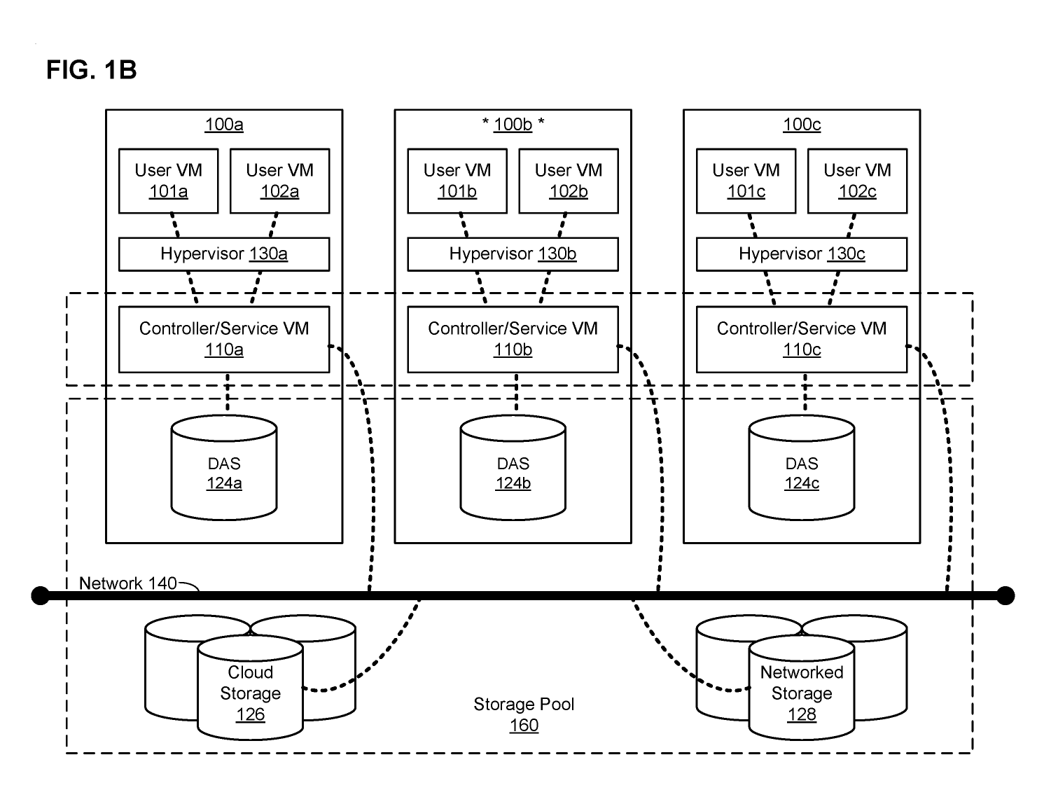

FIG. 1A illustrates a clustered virtualization environment according to some embodiments of the invention. The architecture of FIG. 1A can be implemented for a distributed platform that contains multiple hardware nodes 100a-c that manage multiple tiers of storage. The multiple tiers of storage may include network-attached storage (NAS) that is accessible through network 140, such as, by way of example and not limitation, cloud storage 126, which may be accessible through the Internet, or local network-accessible storage 128 (e.g., a storage area network (SAN)). Unlike the prior art, the present embodiment also permits direct-attached storage (DAS) 124a-c that is within or directly attached to the server and/or appliance to be managed as part of storage pool 160. Examples of such storage include Solid State Drives (henceforth “SSDs”), Hard Disk Drives (henceforth “HDDs” or “spindle drives”), optical disk drives, external drives (e.g., a storage device connected to a hardware node via a native drive interface or a direct attach serial interface), or any other directly attached storage. These collected storage devices, both local and networked, form storage pool 160. Virtual disks (or “vDisks”) can be structured from the storage devices in storage pool 160, as described in more detail below. As used herein, the term vDisk refers to the storage abstraction that is exposed by a Controller/Service VM to be used by a user VM. In some embodiments, the vDisk is exposed via iSCSI (“internet small computer system interface”) or NFS (“network file system”) and is mounted as a virtual disk on the user VM.

Each hardware node 100a-c runs virtualization software, such as VMWARE ESX(I), MICROSOFT HYPER-V, or REDHAT KVM. The virtualization software includes hypervisor 130a-c to manage the interactions between the underlying hardware and the one or more user VMs 101a, 102a, 101b, 102b, 101c, and 102c that run client software. Though not depicted in FIG. 1A, a hypervisor may connect to network 140.

Special VMs 110a-c are used to manage storage and input/output (“I/O”) activities according to some embodiment of the invention, which are referred to herein as “Controller/Service VMs”. These special VMs act as the storage controller in the currently described architecture. Multiple such storage controllers coordinate within a cluster to form a single-system. Controller/Service VMs 110a-c are not formed as part of specific implementations of hypervisors 130a-c. Instead, the Controller/Service VMs run as virtual machines on the various hardware nodes 100, and work together to form a distributed system 110 that manages all the storage resources, including DAS 124a-c, networked storage 128, and cloud storage 126. The Controller/Service VMs may connect to network 140 directly, or via a hypervisor. Since the Controller/Service VMs run independent of hypervisors 130a-c, this means that the current approach can be used and implemented within any virtual machine architecture, since the Controller/Service VMs of embodiments of the invention can be used in conjunction with any hypervisor from any virtualization vendor.

A hardware node may be designated as a leader node. For example, hardware node 100b, as indicated by the asterisks, may be a leader node. A leader node may have a software component designated as a leader. For example, a software component of Controller/Service VM 110b may be designated as a leader. A leader may be responsible for monitoring or handling requests from other hardware nodes or software components on other hardware nodes throughout the virtualized environment. If a leader fails, a new leader may be designated. In particular embodiments, a management module (e.g., in the form of an agent) may be running on the leader node.

Each Controller/Service VM 110a-c exports one or more block devices or NFS server targets that appear as disks to user VMs 101a-c and 102a-c. These disks are virtual, since they are implemented by the software running inside Controller/Service VMs 110a-c. Thus, to user VMs 101a-c and 102a-c, Controller/Service VMs 110a-c appear to be exporting a clustered storage appliance that contains some disks. All user data (including the operating system) in the user VMs 101a-c and 102a-c reside on these virtual disks.

Significant performance advantages can be gained by allowing the virtualization system to access and utilize DAS 124 as disclosed herein. This is because I/O performance is typically much faster when performing access to DAS 124 as compared to performing access to networked storage 128 across a network 140. This faster performance for locally attached storage 124 can be increased even further by using certain types of optimized local storage devices, such as SSDs. Further details regarding methods and mechanisms for implementing the virtualization environment illustrated in FIG. 1A are described in U.S. Pat. No. 8,601,473, which is hereby incorporated by reference in its entirety.

FIG. 1B illustrates data flow within an example clustered virtualization environment according to some embodiments of the invention. As described above, one or more user VMs and a Controller/Service VM may run on each hardware node 100 along with a hypervisor. As a user VM performs I/O operations (e.g., a read operation or a write operation), the I/O commands of the user VM may be sent to the hypervisor that shares the same server as the user VM. For example, the hypervisor may present to the virtual machines an emulated storage controller, receive an I/O command and facilitate the performance of the I/O command (e.g., via interfacing with storage that is the object of the command, or passing the command to a service that will perform the I/O command). An emulated storage controller may facilitate I/O operations between a user VM and a vDisk. A vDisk may present to a user VM as one or more discrete storage drives, but each vDisk may correspond to any part of one or more drives within storage pool 160. Additionally or alternatively, Controller/Service VM 110a-c may present an emulated storage controller either to the hypervisor or to user VMs to facilitate I/O operations. Controller/Service 110a-c may be connected to storage within storage pool 160. Controller/Service VM 110a may have the ability to perform I/O operations using DAS 124a within the same hardware node 100a, by connecting via network 140 to cloud storage 126 or networked storage 128, or by connecting via network 140 to DAS 124b-c within another node 100b-c (e.g., via connecting to another Controller/Service VM 110b-c). In particular embodiments, any suitable computing system 400 may be used to implement a hardware node 100.

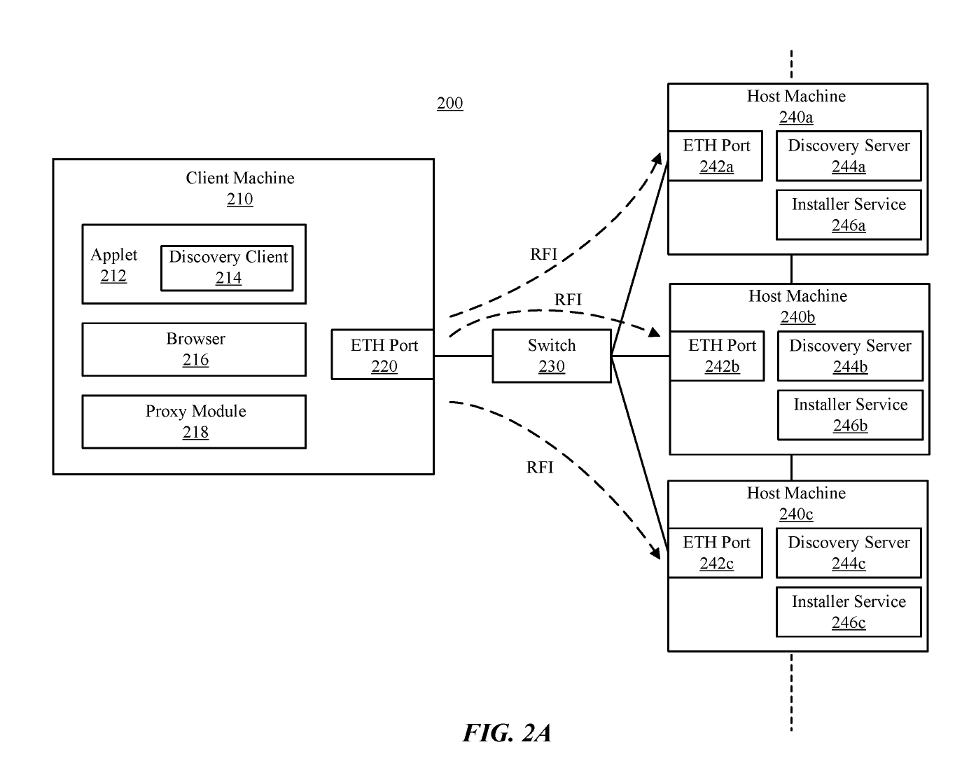

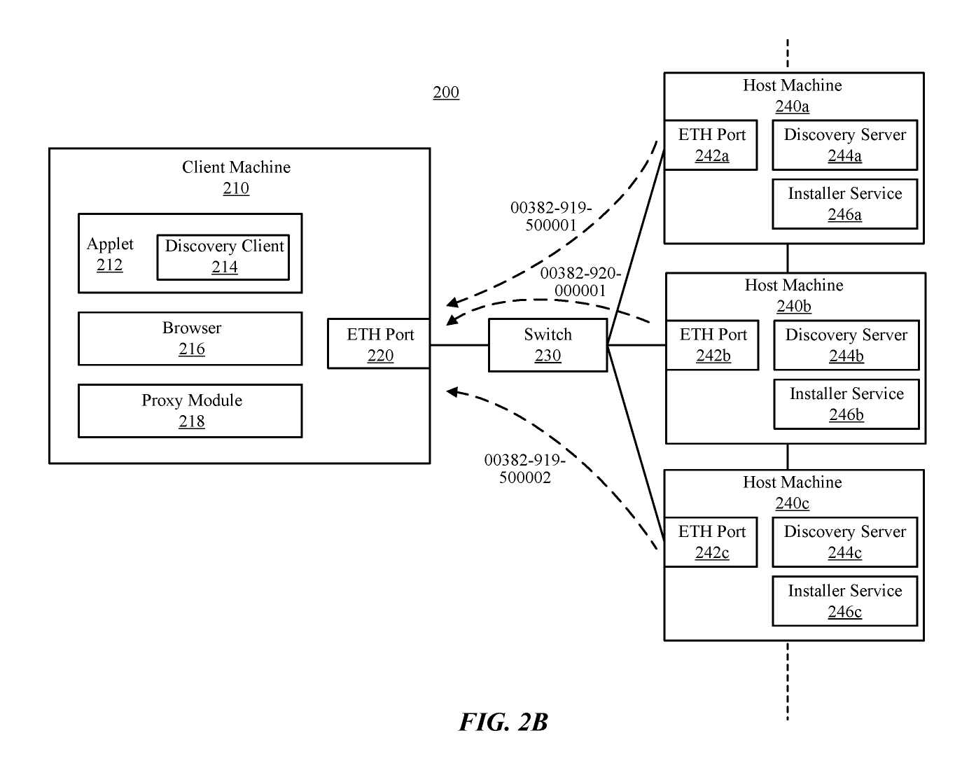

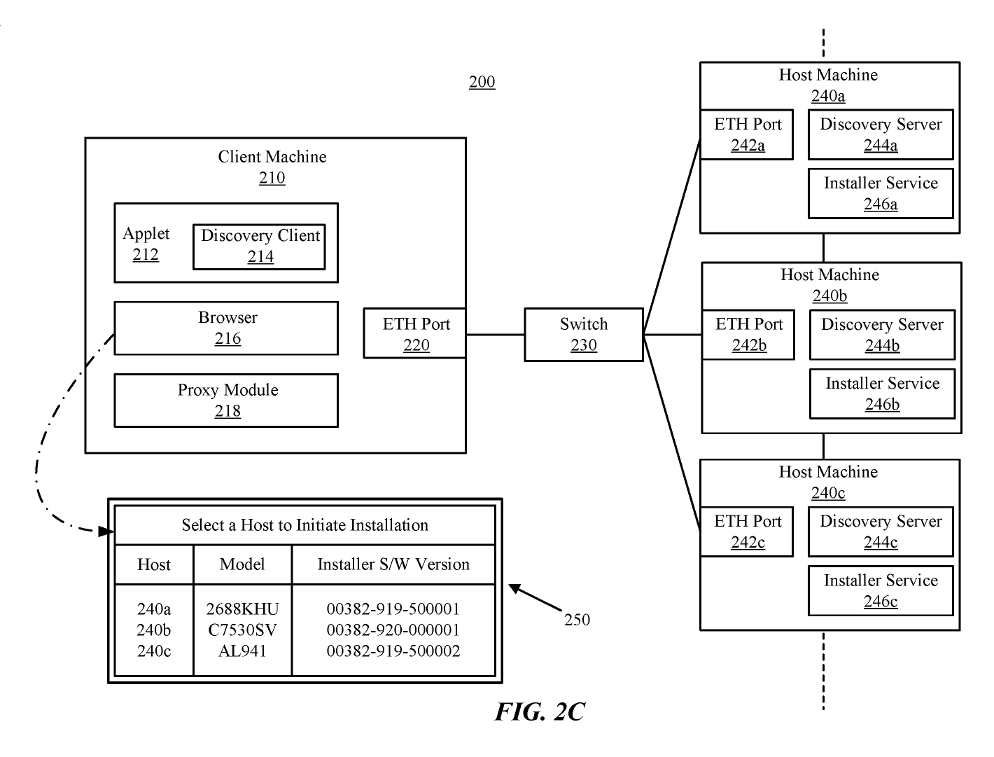

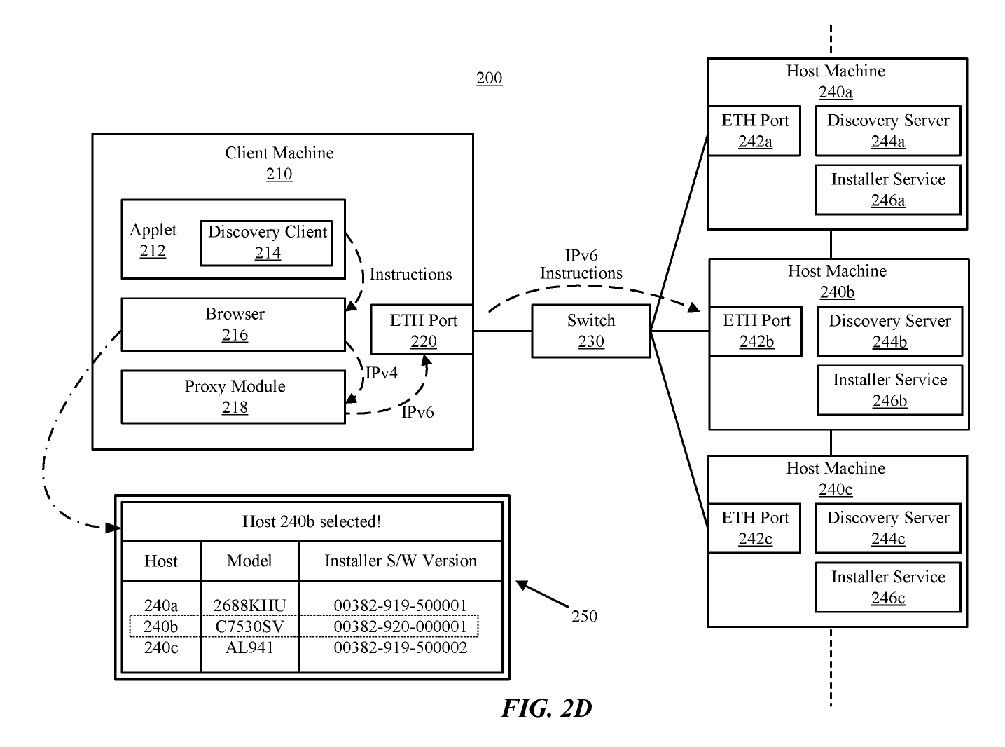

FIGS. 2A-2D illustrate an example network environment implementing an example discovery protocol according to particular embodiments of the invention. In particular embodiments, the network environment 200 may comprise a client machine 210. The client machine 210 may comprise a computing system controlled by an administrator of a virtualization environment. It may comprise one or more display devices and one or more input/output devices. The administrator may directly interact with the client machine 210 or interact with one or more other computing systems in the network environment 200 via the client machine 210. In particular embodiments, the network environment 200 may comprise one or more host machines 240. The host machines 240 may each be configured or configurable to run virtualization software and to serve as a hardware node of a clustered virtualization environment. Each of the host machines 240 may be connected to multiple or all of the other host machines 240 within the network environment 200. In particular embodiments, the network environment 200 may comprise a switch 230. The switch 230 may connect the client machine 210 to a plurality of host machines 240. It may receive data from one or more computing systems, process data, or forward data to one or more computing systems. Within the network environment 200, a particular computing system may communicate with one or more other computing systems by unicast, multicast, or broadcast.

In particular embodiments, the client machine 210 may comprise a first software module for communicating with or managing one or more host machines 240. In particular embodiments, the first software module may be an applet 212 (or another type of application) installed on the client machine 210. The applet 212 may comprise a discovery client 214 configured to implement one or more discovery protocols. The client machine 210 may further comprise a software application capable of sending requests to network addresses. In particular embodiments, the software application may comprise a web browser 216. The web browser 216 may be, for example, MICROSOFT EDGE, MICROSOFT INTERNET EXPLORER, GOOGLE CHROME or MOZILLA FIREFOX, and may have one or more add-ons, plug-ins, or other extensions. The web browser 216 may be configured to receive instructions from the applet 212 and send data to the applet 212. The web browser 216 may be capable of sending requests to Internet Protocol Version 4 (“IPv4”) addresses. In particular embodiments, the web browser 216 may not be capable of accepting Internet Protocol Version 6 (“IPv6”) link local addresses. The client machine 210 may also comprise a proxy module 218. The proxy module 218 may be capable of converting IPv4 addresses to IPv6 link local addresses. The client machine 210 may further comprise an Ethernet port 220 connecting the client machine 210 to the switch 230 or one or more host machines 240.

In particular embodiments, each of the host machines 240 may comprise a second software module. The second software module may be executable by a given one of the host machines 240 for communicating with the first software module. In particular embodiments, the second software module may comprise a discovery server 244. The discovery server 244 may be capable of communicating with the discovery client 214 via the network. The communications by the discovery server 244 may include listening to and receiving requests for information from the discovery client 214 and sending responses to such requests to the discovery client 214. At least one of the host machines 240 may further run an installer service 246 for managing one or more host machines 240. The installer service 246 may comprise an installer capable of installing software on one or more host machines 240. The installer may install software via a web server. The software programs installed may comprise virtualization software. The installer service 246 may be capable of reimaging one or more host machines 240. The installer service 246 may alternatively or additionally be capable of registering a host machine to a clustered virtualization environment and assigning an IP address to the host machine. Each of the host machines 240 may further comprise an Ethernet port 242 connecting the respective host machine 240 to the switch 230, the client machine 210, or one or more other host machines 240.

In particular embodiments, one or more of the host machines 240 may be assigned to a clustered system. Alternatively, or additionally, one or more of the host machines 240 may not be assigned to the clustered system. Such unregistered host machines may not be configured with assigned IP addresses. For any given host machine 240 not assigned to a clustered system, there may be no hypervisor or other virtualization software installed on the host machine 240. Such unregistered host machines 240 may comprise a newly-manufactured computing system with original equipment manufacturer (OEM) settings. Such an unregistered host machine 240, therefore, may not have necessary software configurations to serve as a hardware node for a clustered virtualization environment. An unregistered host machine 240 may have been pre-configured with a discovery server 244 and installer service 246. In particular embodiments, other computing systems connected to an unregistered host machine 240 may not have identification and configuration information associated with the host machine 240 and may not have address information needed to communicate with the host machine 240.

In particular embodiments, the administrator of a clustered system may desire to manage one or more host machines 240 via the client machine 210. Specifically, the administrator may desire to install virtualization software on one or more newly-added host machines 240 and assign the host machines 240 to a clustered virtualization environment. In case one or more host machines 240 are remotely connected to the client machine 210, the administrator may not physically have access to the host machines 240. Initially, information about one or more of the host machines 240, such as information about the identification, configuration, network connectivity, and software associated with the host machines 240, may not be available to the administrator. As an example and not by way of limitation, one or more of the host machines 240 may not be locatable using an IP address as none has been assigned.

In particular embodiments, the client machine 210 may discover one or more host machines 240 based on a discovery protocol. As illustrated by FIG. 2A, the client machine 210 may cause the first software module (e.g., the discovery client 214) to send, via the Ethernet port 220, a request for information to a plurality of host machines 240. The request for information may be sent as a multicast to a selected group of host machines 240 connected to the network environment 200 (e.g., host machines 240a-c). It may alternatively be broadcasted to all host machines 240 reachable by the client machine 210. The request for information may be sent as a User Datagram Protocol (“UDP”) packet or based on another suitable transport layer protocol. Such a protocol may allow data transmission without prior communications. The protocol used (e.g., UDP) may or may not guarantee successful delivery or avoid duplication. The request for information may be repetitively sent for a specified number of times to address the problem of data loss during transmission and to increase the number of host machines 240 receiving the request. The request for information may be written in the format of JavaScript Object Notation (“JSON”) or another suitable data-interchange format. The request for information may seek, from each of the receiving host machines 240, for example, identification information (e.g., name, serial number), hardware model information (e.g., model numbers), network position (e.g., IP address if available, Ethernet port number), version of virtualization software (e.g., version of hypervisor if available), configuration status (e.g., whether the host machine 240 has been assigned to a clustered system), registration type, information about any installer service 246 available (e.g., protocol ID, version number of the software for the installer service 246), other suitable information, or any combination thereof.

In particular embodiments, as illustrated by FIG. 2B, one or more of the host machines 240, after receiving a request for information from the client machine 210, may each send a response to the client machine 210. The response may be sent using the discovery server 244 on the host machine 240. The responses may be generated in the JSON format or another suitable data-interchange format and sent as UDP packets or packets according to another suitable protocol. In particular embodiments, the responses may be unicasted to the client machine 210, since the identity and network position of the client machine 210 are known to each host machine 240 that has received a request for information from the client machine 210. Unicast may have the advantage of avoiding network congestion. A host machine 240 may provide, in a response, one or more of the categories of information requested by the client machine 210. Specifically, the host machine 240 may communicate in a response whether it has necessary configurations (e.g., necessary virtualization software, assigned IP address) to serve as a hardware node of a clustered virtualization environment and whether it is running the installer service 246 for managing one or more host machines 240. The response sent by the host machine 240 may further comprise a version identifier of the software for the installer service 246 (if one is available). As an example and not by way of limitation, as illustrated by FIG. 2B, the host machine 240a may comprise an installer service 246a associated with software of version 00382-919-500001; the host machine 240b may comprise an installer service 246b associated with software of version 00382-920-000001; the host machine 240c may comprise an installer service 246c associated with software of version 00382-919-500002. The host machines 240a-c may communicate such version numbers to the client machine 210 in responses sent to the client machine 210.

In particular embodiments, as illustrated by FIG. 2C, the client machine 210 may generate, based on the responses sent by one or more host machines 240, a list (or table) 250 comprising information about the host machines 240. As an example and not by way of limitation, the list 250 may comprise identifiers (e.g., A, B, C) for the responding host machines 240, model numbers (e.g., 2688KHU, C7530SV, AL941) for the host machines 240, and version identifiers (e.g., 00382-919-500001, 00382-920-000001, 00382-919-500002) of the software for the installer service 246 running on the host machines. The list 250 may alternatively or additionally comprise a plurality of other information (e.g., configuration status, IP address, virtualization software type). The list 250 may be generated or stored with any suitable data structure. The client machine 210 may cause the software application to display the list 250. In particular embodiments, the list 250 may be displayed by the web browser 216 on a display device or be stored in a storage device associated with the client machine 210. In particular embodiments, the administrator may review the list 250 and select at least one of the listed host machines 240 running the installer service 246. As an example and not by way of limitation, the administrator may select one of the host machines 240 that is running the newest version or the most preferred version of the software for the installer service 246. Here, the host machine 240b may be selected because it is running the newest version (e.g., 00382-920-000001) of software for the installer service 246b. As another example and not by way of limitation, the administrator may select one of the host machines 240 with desirable computing capabilities based on the model numbers of the host machines 240. Alternatively, the client machine 210, particularly the first software module or the applet 212, may be configured to automatically select one of the host machines 240 based on the information included in the list 250.

In particular embodiments, as illustrated by FIG. 2D, the client machine 210 may send instructions to the selected host machine 240b. Within the client machine 210, the first software module or applet 212 may launch a web browser 216 with instructions to connect to the selected host machine 240b. The user may then provide user input (through the web browser 216) to send instructions to the selected host machine 240b. The selected host machine 240b, however, may be configured to receive requests addressed using the IPv6 protocol. To address this incompatibility in internet-layer protocols, the proxy module 218 may intercept the request sent by the web browser 216, convert the IPv4 address of the request into an IPv6 link local address associated with the host machine 240b, and send the instructions to the IPv6 address via a Transmission Control Protocol (“TCP”) connection. The instructions may be executable by the installer service 246b to perform one or more tasks on one or more host machines 240 (e.g., installing software, assigning IP address).

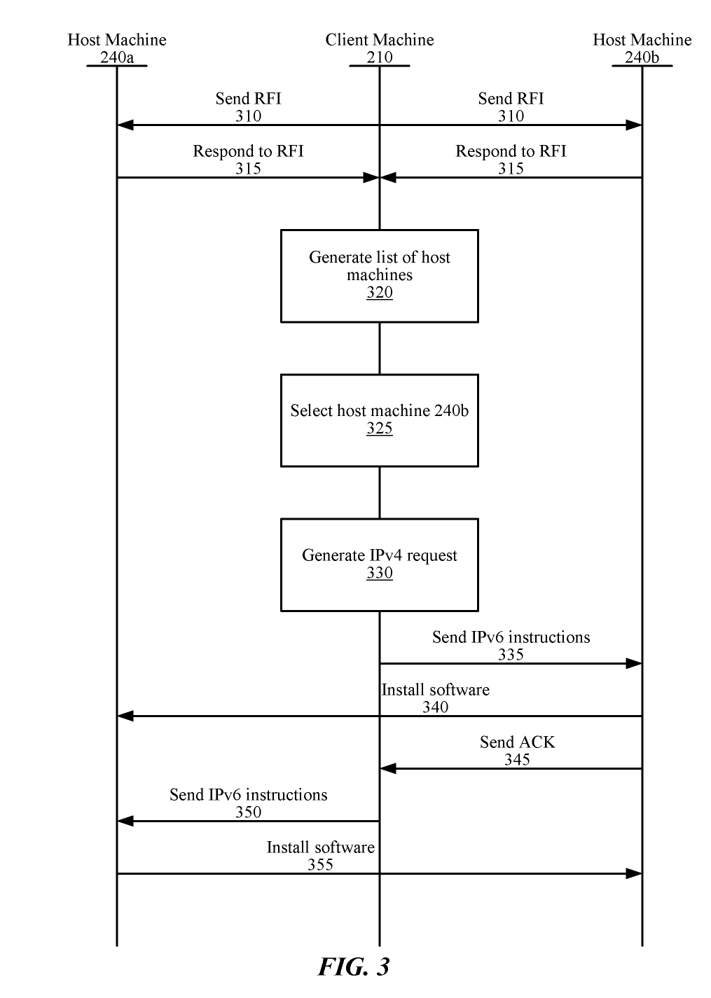

FIG. 3 illustrates an example method for discovering host machines and installing software on the discovered host machines according to some embodiments of the invention. In particular, FIG. 3 illustrates interactions among a client machine 210 and two example host machines 240a and 240b according to particular embodiments of the invention. Only two host machines 240a and 240b are included in FIG. 3 due to space limitations. The method illustrated by FIG. 3 may be applied to more than two host machines 240. At step 310, the client machine 210 may cause a first software module (e.g., the applet 212) to send a request for information to a plurality of host machines 240 (exemplified by host machines 240a and 240b). The request for information may be sent as a multicast to a selected group of host machines 240 connected to the network environment 200. It may alternatively be broadcasted to all host machines 240 reachable by the client machine 210. The request for information may be sent as a UDP packet or based on another suitable transport layer protocol. The protocol may allow data transmission without prior communications. The request for information may be written in the format of JSON or another suitable data-interchange format. The request for information may seek, from each of the receiving host machines 240, for example, identification information (e.g., name, serial number), hardware model information (e.g., model numbers), network position (e.g., IP address if available, Ethernet port number), version of virtualization software (e.g., version of hypervisor if available), configuration status (e.g., whether the of the host machines 240 has been assigned to a clustered system), registration type, information about any installer service 246 available (e.g., protocol ID, version number of the software for the installer service 246), other suitable information, or any combination thereof.

The transport layer protocol used (e.g., UDP) may or may not guarantee successful delivery. As an example and not by way of limitation, the UDP protocol may not have a “handshake” protocol before transmitting data and hence may expose the data transmission to unreliability of the underlying network. To address the problem of delivery failures due to network unreliability and to increase the number of host machines 240 that the request for information may reach, client machine 210 may cause the first software module or the applet 212 to send a request for information multiple times. The number of deliveries (e.g., 10 times) of the request for information may be set by the administrator. In particular embodiments, the network environment 200 may comprise a large number (e.g., 1000) of host machines 240 that are reachable by the client machine 210. If the client machine 210, for example, repetitively sends requests for information to all of the host machines 240, the client machine 210 may be overloaded with repeated responses from the host machines 240. Specifically, one or more queues used to store responses (e.g., maintained either by the client machine 210 and/or by one or more network switches) may be filled quickly, which may cause loss of packets. To address this problem, the client machine 210 may divide the available host machines 240 into a series of subgroups before sending the requests for information. As an example and not by way of limitation, the client machine 210 may employ a hash technique which assigns an index to each available host machine and uses a modulo function to assign the host machines to different subgroups based on their corresponding indexes. The request for information may be sent multiple times to all of the host machines 240 over multiple phases of time. However, in this embodiment, the request for information may include the modulo and an offset (e.g., determined in round-robin fashion), and each of the host machines may determine whether or not to respond to any particular request by (1) applying the transmitted modulo to the cryptographic digest of their serial number (or other id) and then (2) comparing the result to the transmitted offset. Each phase of time may include a first period of time during which the request for information is sent and a second period of time during which responses from a subgroup of the host machines are collected. The client machine 210 may consolidate the results received from a particular subgroup of host machines 240 in a particular phase of time before updating the offset in order to move on to the next subgroup of host machines 240.

At step 315, the host machines 240 may send responses to the client machine 210. The response may be sent by the discovery servers 244 on the host machines 240. The responses may be generated in the JSON format or another suitable data-interchange format and sent as UDP packets or packets according to another suitable protocol. In particular embodiments, the responses may be unicasted to the client machine 210, since the identity and network position of the client machine 210 are known to each of the host machines 240 that has received a request for information from the client machine 210. Unicast may have the advantage of avoiding network congestion. A host machine 240 may provide, in a response, one or more of the categories of information requested by the client machine 210. Each of the responses may comprise information identifying the host machine 240 sending the response and information associated with a type of the host machine 240. Additionally, at least one of the responses may be sent by a host machine 240 running the installer service 246 for managing one or more host machines 240. The response may further comprise information associated with a version of the software for the installer service 246 running on the host machine 240.

At step 320, the client machine 210 may generate, based on the responses sent by the host machines 240, a list 250 comprising information about the host machines 240. The client machine 210 may then cause the web browser 216 to display the generated list 250. As an example and not by way of limitation, the list 250 may comprise identifiers for the responding host machines 240, model numbers for the host machines 240, and version identifiers of the software for the installer service 246 running on the host machines 240 if the installer service 246 is available. The list 250 may alternatively or additionally comprise a plurality of other information (e.g., configuration status, IP address, virtualization software type). The list 250 may be generated or stored with any suitable data structure. In particular embodiments, the protocol (e.g., UDP) used for exchanging requests for information and responses between the client machine 210 and the host machines 240 may not protect against duplications. If the client machine 210 caused the applet 212 to send a request for information multiple times, it may receive multiple duplicated responses for each responding host machine 240. In this case, the client machine 210 may consolidate the responses to eliminate duplicate responses based on the information identifying the host machines 240 before generating the list 250. As an example and not by way of limitation, the client machine may send a request for information to host machines 240a and 240b for ten times. It may receive, for example, nine responses containing identification information for the host machine 240a and eight responses containing identification information for the host machine 240b. The client machine may consolidate the responses containing the same identification information such that only one response is retained for each of the host machines 240a and 240b.

At step 325, the host machine 240b may be selected from the list 250 of host machines 240. In particular embodiments, the administrator may review the list 250 and select at least one of the listed host machines 240 running the installer service 246. As an example and not by way of limitation, the administrator may select a host machine 240 running the newest version or the most preferred version of software for the installer service 246. Here, the host machine 240b may be selected because it is running the newest version of software for the installer service 246b. Alternatively, the client machine 210, particularly the first software module or the applet 212, may be configured to automatically select a host machine 240 based on the information included in the list 250. Here, the client machine 210 may automatically determine that the host machine 240b is the most desirable host machine from which to run the installer service 246.

At step 330, the client machine 210 may generate a request formatted with an IPv4 address using the web browser. Within the client machine 210, the first software module or applet 212 may instruct a web browser to connect to selected host machine 240b and send the instructions to the software application. In particular embodiments, the web browser 216 may be capable of sending requests to IPv4 addresses and not capable of accepting IPv6 link local addresses. The web browser 216 may forward the instructions as a request formatted with an IPv4 address to the selected host machine 240b.

At step 335, the client machine 210 may send instructions using an IPv6 link local address to the selected host machine 240b. In particular embodiments, the selected host machine 240b may be configured to receive requests addressed using the IPv6 protocol. It may not be reachable using the IPv4 address formatted by the web browser 216. To address this difference in internet-layer protocols, the proxy module 218 may intercept the request forwarded by the web browser 216, convert the IPv4 address of the request into an IPv6 link local address associated with the host machine 240b, and send the instructions to the IPv6 address via a TCP connection. The host machine 240b may then receive the instructions sent by the client machine 210.

At step 340, the host machine 240b may execute the instructions sent by the client machine 210 to install software on at least one of the other host machines 240a. The software may only be installed on host machines 240 that have not been assigned to a clustered virtualization environment. In particular embodiments, the host machine 240b may activate the installer service 246b in response to the received instructions. The installer service 246b may initiate an installation wizard, which may be proxied to the client machine 210 via the applet 212. The web browser 216 may display a user interface associated with the installation wizard to the administrator. Within the user interface, the administrator may remotely instruct the installer service 246b to install one or more software programs on the host machines including the host machine 240a. The installer service 246b may comprise an installer capable of installing software on one or more host machines 240. The installer may install software via a web server. It may be capable of installing software by reimaging a host machine 240. The software programs installed may comprise virtualization software necessary for the host machine 240a to serve as a hardware node in a clustered virtualization environment. They may also comprise a copy of the installer service 246b, such that the installer service 246a running on the host machine 240a, after the installation, will be associated with software of a same version as that of the installer service 246b. The software programs installed may further comprise one or more other suitable programs. The installer service 246b may alternatively or additionally be capable of registering a host machine 240a to a clustered virtualization environment and assigning an IP address to the host machine 240a. The administrator may remotely instruct the installer service 246b to assign the host machine 240a to a clustered system, to form a new cluster, or to configure an IP address for the host machine 240a. After installing software on one or more host machines including the host machine 240a, the host machine 240b may terminate the installer service 246b.

At step 345, the selected host machine 240b may send an acknowledgment (ACK) message back to the client machine 210 upon completion of installation of the software on at least one of the other host machines 240, including the host machine 240a. The ACK message may confirm completion of the installation process. It may additionally comprise information associated with another one (e.g., the host machine 240a) of the host machines 240 such as identification information or a port number. In particular embodiments, if the installer service 246b installs software by reimaging another host machine 240, it may not be capable of installing software on the host machine 240b, which runs the installer service 246b. Installing software on the host machine 240b may require another host machine 240 running the installer service 246. In case the host machine 240b needs installation of the software, it may identify in its ACK message to the client machine 210 another host machine 240a, which may be used to install software on the host machine 240b. The identification of the other host machine 240a may be based on instructions from the administrator.

At step 350, the client machine 210 may repeat step 335, but with respect to the host machine 240a rather than the host machine 240b. In particular embodiments, the host machine 240a may have been selected by the host machine 240b and communicated to the client machine 210. Alternatively, the client machine 210 may proactively select the host machine 240a based on information included in the list of host machines 250. It may send instructions using an IPv6 link local address to the host machine 240a instructing the host machine 240a to install software on the host machine 240b. In particular embodiments, the client machine 210 may cause the web browser 216 to send a request formatted with an IPv4 address specifying the host machine 240a. The client machine 210 may then cause the proxy module 218 to intercept the request formatted with the IPv4 address and send instructions using an IPv6 link local address to the host machine 240a via a TCP connection.

At step 355, the host machine 240a may execute the instructions sent by the client machine 210 to install software on the host machine 240b. In particular embodiments, the host machine 240a may initially be running an installer service 246a associated with software that is of an older or less preferred version than that for the installer service 246b run by the host machine 240b. As discussed above, the software for the installer service 246a may have been updated, at step 340, to the same version as that of the software for the installer service 246b. The software installed on the host machine 240b, by the updated installer service 246a, may therefore be identical to the software installed on the host machine 240a.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for discovering host machines and installing software on the discovered host machines including the particular steps of the method of FIG. 3, this disclosure contemplates any suitable method for discovering host machines and installing software on the discovered host machines including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

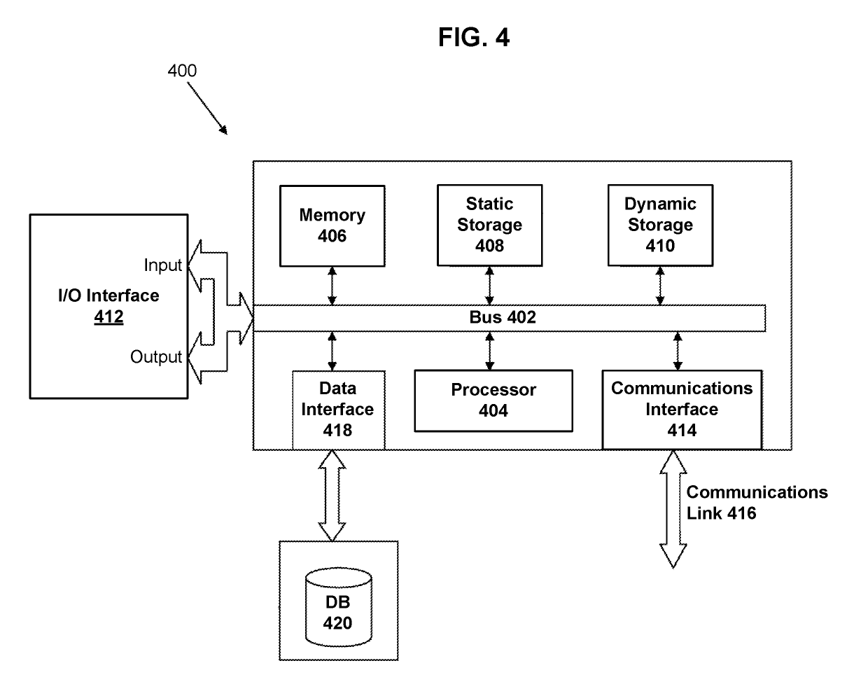

FIG. 4 is a block diagram of an illustrative computing system 400 suitable for implementing an embodiment of the present invention. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a mainframe, a mesh of computer systems, a server, a laptop or notebook computer system, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

Computer system 400 includes a bus 402 (e.g., an address bus and a data bus) or other communication mechanism for communicating information, which interconnects subsystems and devices, such as processor 404, memory 406 (e.g., RAM), static storage 408 (e.g., ROM), dynamic storage 410 (e.g., magnetic or optical), communication interface 414 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), input/output (I/O) interface 412 (e.g., keyboard, keypad, mouse, microphone). In particular embodiments, computer system 400 may include one or more of any such components.

In particular embodiments, processor 404 includes hardware for executing instructions, such as those making up a computer program. As an example and not by way of limitation, to execute instructions, processor 404 may retrieve (or fetch) the instructions from an internal register, an internal cache, memory 406, static storage 408, or dynamic storage 410; decode and execute them; and then write one or more results to an internal register, an internal cache, memory 406, static storage 408, or dynamic storage 410. In particular embodiments, processor 404 may include one or more internal caches for data, instructions, or addresses. This disclosure contemplates processor 404 including any suitable number of any suitable internal caches, where appropriate. As an example and not by way of limitation, processor 404 may include one or more instruction caches, one or more data caches, and one or more translation lookaside buffers (TLBs). Instructions in the instruction caches may be copies of instructions in memory 406, static storage 408, or dynamic storage 410, and the instruction caches may speed up retrieval of those instructions by processor 404. Data in the data caches may be copies of data in memory 406, static storage 408, or dynamic storage 410 for instructions executing at processor 404 to operate on; the results of previous instructions executed at processor 404 for access by subsequent instructions executing at processor 404 or for writing to memory 406, static storage 408, or dynamic storage 410; or other suitable data. The data caches may speed up read or write operations by processor 404. The TLBs may speed up virtual-address translation for processor 404. In particular embodiments, processor 404 may include one or more internal registers for data, instructions, or addresses. This disclosure contemplates processor 404 including any suitable number of any suitable internal registers, where appropriate. Where appropriate, processor 404 may include one or more arithmetic logic units (ALUs); be a multi-core processor; or include one or more processors 402. Although this disclosure describes and illustrates a particular processor, this disclosure contemplates any suitable processor.

In particular embodiments, I/O interface 412 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 412 for them. Where appropriate, I/O interface 412 may include one or more device or software drivers enabling processor 404 to drive one or more of these I/O devices. I/O interface 412 may include one or more I/O interfaces 412, where appropriate. Although this disclosure describes and illustrates a particular I/O interface, this disclosure contemplates any suitable I/O interface.

In particular embodiments, communication interface 414 includes hardware, software, or both providing one or more interfaces for communication (such as, for example, packet-based communication) between computer system 400 and one or more other computer systems 400 or one or more networks. As an example and not by way of limitation, communication interface 414 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 414 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 414 for any of these networks, where appropriate. Communication interface 414 may include one or more communication interfaces 414, where appropriate. Although this disclosure describes and illustrates a particular communication interface, this disclosure contemplates any suitable communication interface.

One or more memory buses (which may each include an address bus and a data bus) may couple processor 404 to memory 406. Bus 402 may include one or more memory buses, as described below. In particular embodiments, one or more memory management units (MMUs) reside between processor 404 and memory 406 and facilitate accesses to memory 406 requested by processor 404. In particular embodiments, memory 406 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 406 may include one or more memories 406, where appropriate. Although this disclosure describes and illustrates particular memory, this disclosure contemplates any suitable memory.

Where appropriate, the ROM may be mask-programmed ROM, programmable ROM (PROM), erasable PROM (EPROM), electrically erasable PROM (EEPROM), electrically alterable ROM (EAROM), or flash memory or a combination of two or more of these. In particular embodiments, dynamic storage 410 may include a hard disk drive (HDD), a floppy disk drive, flash memory, an optical disc, a magneto-optical disc, magnetic tape, or a Universal Serial Bus (USB) drive or a combination of two or more of these. Dynamic storage 410 may include removable or non-removable (or fixed) media, where appropriate. Dynamic storage 410 may be internal or external to computer system 400, where appropriate. This disclosure contemplates mass dynamic storage 410 taking any suitable physical form. Dynamic storage 410 may include one or more storage control units facilitating communication between processor 404 and dynamic storage 410, where appropriate.

In particular embodiments, bus 402 includes hardware, software, or both coupling components of computer system 400 to each other. As an example and not by way of limitation, bus 402 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 402 may include one or more buses 406, where appropriate. Although this disclosure describes and illustrates a particular bus, this disclosure contemplates any suitable bus or interconnect.

According to one embodiment of the invention, computer system 400 performs specific operations by processor 404 executing one or more sequences of one or more instructions contained in memory 406. Such instructions may be read into memory 406 from another computer readable/usable medium, such as static storage 408 or dynamic storage 410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 404 for execution. Such a medium may take many forms, including but not limited to, nonvolatile media and volatile media. Non-volatile media includes, for example, optical or magnetic disks, such as static storage 408 or dynamic storage 410. Volatile media includes dynamic memory, such as memory 406.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 400. According to other embodiments of the invention, two or more computer systems 400 coupled by communication link 416 (e.g., LAN, PTSN, or wireless network) may perform the sequence of instructions required to practice the invention in coordination with one another.

Computer system 400 may transmit and receive messages, data, and instructions, including program, i.e., application code, through communication link 416 and communication interface 414. Received program code may be executed by processor 404 as it is received, and/or stored in static storage 408 or dynamic storage 410, or other non-volatile storage for later execution. A database 420 may be used to store data accessible by the system 400 by way of data interface 418.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A system for managing host machines, comprising:
a client machine executing a first software module for managing host machines, wherein the client machine is connected to a network, wherein the client machine is installed with a software application capable of sending requests to IPv4 addresses and not capable of resolving IPv6 link local addresses, and wherein the client machine comprises a proxy module for converting IPv4 addresses to IPv6 link local addresses; and
a plurality of host machines, wherein each of the host machines is executing a second software module for communicating with the first software module, and wherein at least one of the host machines is running a service for managing one or more host machines;
wherein the client machine causes the first software module to send a request for information to the plurality of host machines;
wherein the host machines send responses to the client machine, each of the responses comprising information identifying the host machine sending the response and information associated with a type of the host machine;
wherein the client machine sends a request formatted with an IPv4 address using the software application; and
wherein the client machine causes the proxy module to intercept the request formatted with the IPv4 address and send instructions using an IPv6 link local address to a selected one of the host machines running the service for managing the one or more host machines.

2. The system of claim 1, wherein each of one or more of the host machines is not assigned to a cluster.

3. The system of claim 1, wherein each of one or more of the host machines is not configured with an assigned IP address.

4. The system of claim 1, wherein, for each of one or more of the host machines, no hypervisor software is installed on the host machine.

5. The system of claim 1, wherein at least one of the responses is sent by a host machine running the service for managing the one or more host machines, and wherein the response further comprises information associated with a version of the service.

6. The system of claim 1, wherein the client machine generates, based on the responses sent by the host machines, a list comprising information about the host machines, and wherein the client machine causes the software application to display the generated list.

7. The system of claim 1, wherein the instructions sent by the proxy module are executable by the selected host machine to assign an IP address to at least one of the host machines.

8. The system of claim 1, wherein the instructions sent by the proxy module are executable by the selected host machine to cause the service to install software on at least one of the other host machines.

9. The system of claim 8, wherein:
the selected host machine sends a message back to the client machine upon completion of installation of the software on the at least one of the other host machines;
the client machine sends a request using the software application, wherein the request is formatted with an IPv4 address specifying one of the other host machines;
the client machine causes the proxy module to intercept the request formatted with the IPv4 address and send instructions using an IPv6 link local address to the specified one of the other host machines, wherein the instructions are executable to install software on the selected host machine.

10. The system of claim 1, wherein when the client machine causes the first software module to send a request for information to the plurality of host machines, the request for information is sent multiple times; and
wherein the client machine consolidates the responses to eliminate duplicate responses based on the information identifying the host machine.

11. The system of claim 10, wherein the request for information includes a modulo and an offset, and wherein each of the host machines only responds if a unique identifier for the host machine modulo the transmitted modulo equals the transmitted offset.

12. One or more computer-readable non-transitory storage media embodying software that is operable when executed to:
cause a first software module executed by a client machine to send a request for information to a plurality of host machines, wherein:
the client machine executes the first software module for managing host machines, wherein the client machine is connected to a network, wherein the client machine is installed with a software application capable of sending requests to IPv4 addresses and not capable of resolving IPv6 link local addresses, and wherein the client machine comprises a proxy module for converting IPv4 addresses to IPv6 link local addresses, and
each of the host machines is executing a second software module for communicating with the first software module, wherein at least one of the host machines is running a service for managing one or more host machines;
cause the host machines to send responses to the client machine, each of the responses comprising information identifying the host machine sending the response and information associated with a type of the host machine;
cause the client machine to send a request formatted with an IPv4 address using the software application; and
cause the proxy module installed on the client machine to intercept the request formatted with the IPv4 address and to send instructions using an IPv6 link local address to one of the host machines running the service for managing the one or more host machines.

13. The media of claim 12, wherein each of one or more of the host machines is not assigned to a cluster.

14. The media of claim 12, wherein each of one or more of the host machines is not configured with an assigned IP address.

15. The media of claim 12, wherein, for each of one or more of the host machines, no hypervisor software is installed on the host machine.

16. The media of claim 12, wherein at least one of the responses is sent by a host machine running the service for managing the one or more host machines, and wherein the response further comprises information associated with a version of the service.

17. A method for managing host machines, comprising:
causing a first software module executed by a client machine to send a request for information to a plurality of host machines, wherein:
the client machine executes the first software module for managing host machines, wherein the client machine is connected to a network, wherein the client machine is installed with a software application capable of sending requests to IPv4 addresses and not capable of resolving IPv6 link local addresses, and wherein the client machine comprises a proxy module for converting IPv4 addresses to IPv6 link local addresses, and
each of the host machines is executing a second software module for communicating with the first software module, wherein at least one of the host machines is running a service for managing one or more host machines;
causing the host machines to send responses to the client machine, each of the responses comprising information identifying the host machine sending the response and information associated with a type of the host machine;
causing the client machine to send a request formatted with an IPv4 address using the software application; and
causing the proxy module installed on the client machine to intercept the request formatted with the IPv4 address and to send instructions using an IPv6 link local address to one of the host machines running the service for managing the one or more host machines.

18. The method of claim 17, wherein each of one or more of the host machines is not assigned to a cluster.

19. The method of claim 17, wherein each of one or more of the host machines is not configured with an assigned IP address.

20. The method of claim 17, wherein, for each of one or more of the host machines, no hypervisor software is installed on the host machine.
